(19) United States
(12) Patent Application Publication
(10) Pub. No.: US 2007/0197670 A1
(43) Pub. Date: Aug. 23, 2007

(54) Rigidized compliant foam and method for implementing a rigidized compliant foam

(75) Inventor: Joseph Kuczynski, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/360,347

(22) Filed: Feb. 23, 2006

(51) Int. Cl. C08J 9/00

(52) U.S. Cl. 521/50

(57) ABSTRACT

A rigidized compliant foam and a method are provided for implementing a rigidized compliant foam. A compliant foam includes an encapsulated adhesive. The encapsulated adhesive includes a plurality of resin microcapsules and curing agent microcapsules dispersed in a closed cell foam. The rigidized compliant foam is produced following compression of the closed cell foam by a predefined normal force.

### FIELD OF THE INVENTION

The present invention relates generally to the data processing field, and more particularly, relates to a method for implementing a rigidized compliant foam and a rigidized compliant foam.

### DESCRIPTION OF THE RELATED ART

Silicone foam is typically used to accommodate tolerance stack-up issues or to apply a compliant, normal force for direct chip attach assemblies. Two critical material properties of the foam are stiffness and stress relaxation.

Regarding stiffness, the normal force required to compress the foam to a given set point increases with foam stiffness. If the foam is too stiff, this normal force may cause solder creep and/or chip cracking.

If the foam is too soft, the material undergoes excessive stress relaxation which, consequently, results in a reliability exposure for the thermal interface, that is, the normal load relaxes, the bond line increases, and the thermal resistance rises.

Commercially available foams with the proper balance of these two properties are difficult, if not impossible, to come by.

Therefore, a need exists for a rigidized, compliant foam.

### SUMMARY OF THE INVENTION

Principal aspects of the present invention are to provide a method for implementing a rigidized compliant foam and a rigidized compliant foam. Other important aspects of the present invention are to provide such method for implementing a rigidized compliant foam and a rigidized compliant foam substantially without negative effect and that overcome many of the disadvantages of prior art arrangements.

In brief, a rigidized compliant foam and a method are provided for implementing a rigidized compliant foam. A compliant foam includes an encapsulated adhesive. The encapsulated adhesive includes a plurality of resin microcapsules and curing agent microcapsules dispersed in a closed cell foam. The rigidized compliant foam is produced following compression of the closed cell foam by a predefined normal force.

In accordance with features of the invention, a shell of the encapsulated adhesive components or the resin microcapsules and curing agent microcapsules is tailored to rupture at a force prior to that required to achieve the given set point, thereby releasing the adhesive which will begin to set up resulting in a rigid structure. In this fashion, the normal force will not exceed design limits and stress relaxation will be minimized due to the cured structural adhesive within the closed cells of the foam.

A method for implementing a rigidized compliant foam includes the steps of: encapsulating a resin to provide a plurality of resin microcapsules; encapsulating a curing agent to provide a plurality of curing agent microcapsules; producing a closed cell foam having said plurality of resin microcapsules and said plurality of curing agent microcapsules dispersed in said closed cell foam; and compressing said closed cell foam by a predefined normal force to produce the rigidized compliant foam.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a flow chart illustrating exemplary steps for implementing a rigidized compliant foam in accordance with the preferred embodiment.

### DETAILED DESCRIPTION OF THE PREFERRED EMBODIMENTS

In accordance with features of the invention, an effective method is provided to rigidize a compliant foam following compression. Closed cell foams consist of entrapped air bubbles within a base elastomer. The durometer of the foam is determined by the extent of crosslinking of the base resin. The greater the durometer corresponds to a stiffer or higher degree of crosslinking of the foam. Incorporating micro-encapsulated beads or microcapsules containing a room-temperature curable adhesive into the air bubbles provides a means to rigidize the foam following compression.

Micro-encapsulation of two-part, room-temperature curable adhesives is known to those skilled in the art. Epoxy-based threadlockers based on this technology are commercially available. Depending on the required mix ratio of the adhesive, the appropriate ratio of resin to curing agent is incorporated into separate capsules.

In accordance with features of the invention, an outer shell of each capsule is tailored to rupture at a preset pressure. Elastomeric foam is prepared by incorporating the encapsulated adhesive into the closed cells during the foam manufacturing process. For example, the elastomeric base resin and the encapsulated adhesive components are thoroughly mixed then the mixture foamed with a suitable agent. Since the encapsulated adhesive components remain liquid until reacted together, the closed cells in the foam retain a large degree of compressibility, albeit less than an air-filled cavity.

In accordance with features of the invention, by preparing such a foam from a base elastomer with very low stiffness, the normal force required to compress the foam to a given set point is not excessive. However, since the shell of the encapsulated adhesive components is tailored to rupture at a force prior to that required to achieve the given set point, the adhesive will begin to set up resulting in a rigid structure. In this fashion, the normal force will not exceed design limits and stress relaxation will be minimized due to the cured structural adhesive within the closed cells of the foam.

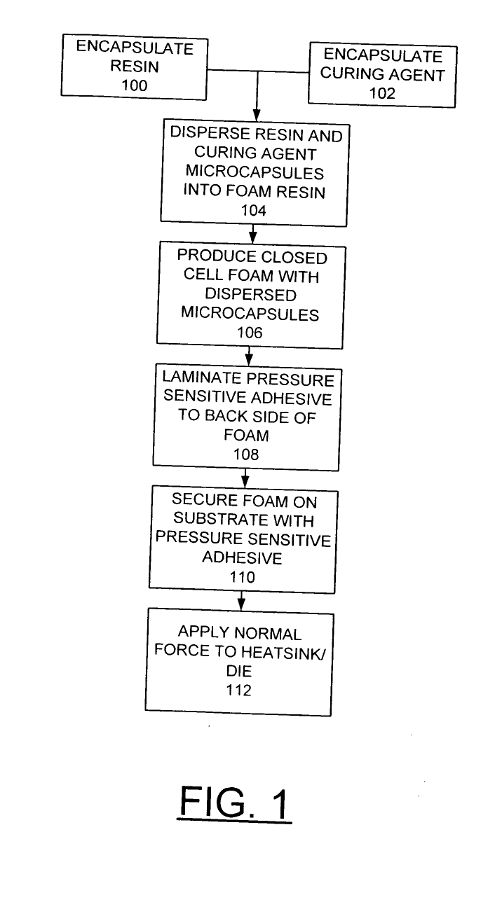

Having reference now to the drawings, in FIG. 1, there is shown a flow chart illustrating exemplary steps for implementing a rigidized compliant foam in accordance with the preferred embodiment.

As indicated in a block 100, a resin is encapsulated. A curing agent is encapsulated as indicated in a block 102. The encapsulated resin and encapsulated curing agent, comprising two components of an encapsulated adhesive, are encapsulated using techniques known to those skilled in the art, forming microcapsules.

In accordance with features of the preferred embodiment, the in situ polymerization of urea formaldehyde shells around the adhesive resin and curing agent results in microcapsules containing the two components of a room-temperature curable adhesive.

In accordance with features of the preferred embodiment, the encapsulated resin is a multifunctional epoxy resin and the encapsulated curing agent is an appropriate curing agent, for example, such as, amine, polyamine, Lewis acid, mercaptans, and mercaptan-terminated polymers, and other epoxy curing agents known to those skilled in the art.

Once the microcapsules are formed the resin and curing agent microcapsules are dispersed into a foam resin as indicated in a block 104. The foam resin includes, for example, a selected one of polyurethane and silicone, while it should be understood that various. other materials can be used for the foam resin. The resin and curing agent microcapsules are dispersed under low shear mixing conditions in order to prevent pre-mature rupture of the shell.

As indicated in a block 106, a closed cell foam is produced by standard techniques. For example, the polyurethane or silicone resin is reacted in the presence of a blowing agent as the material is fed onto a paper liner on a conveyor to form a continuous. sheet. Once the closed cell foam is produced, a pressure sensitive adhesive (PSA) optionally is laminated to a backside of the foam as indicated in a block 108. The foam is secured to a substrate with the pressure sensitive adhesive as indicated in a block 110.

Upon application of a normal force sufficient to compress the foam to the desired setpoint as indicated in a block 112, the microcapsule shell ruptures releasing the adhesive components into the closed cells of the foam.

It should be understood that the pressure required to rupture the shells can be tailored but will always be less than that required to compress the foam to the desired setpoint. Once the adhesive reagents have been released into the cells, room-temperature polymerization occurs and the material hardens within the cells. As a result, the once compliant foam is now rigidized.

Prior art techniques include those whereby the microcapsule is manufactured from gelatin via a simple precipitation process, for example, as disclosed in U.S. Pat. No. 2,183,053 issued Dec. 12, 1939 to Taylor, or a more complex precipitation process such as those generally described in U.S. Pat. No. 2,800,457, and U.S. Pat. No. 2,800,458.

Formation of the microcapsule shell via controlled polymerization has been taught in the prior art. For example, U.S. Pat. No. 2,581,441 teaches the chemical conversion of a normally aqueous. soluble algin to a water insoluble algin which then becomes the capsule shell; U.S. Pat. No. 3,016,308 teaches shell formation by acid catalyzed urea-formaldehyde polymerization of an emulsion stabilized with carboxy methyl cellulose; and U.S. Pat. No. 3,137,631 also teaches shell formation from urea-formaldehyde precursors.

More generally, microcapsules may also be formed by two well-known processes: complex coacervation and interfacial polymerization. Complex coacervation is conducted in aqueous media and is used to encapsulate water insoluble liquids. Gelatin and gum arabic (both natural products) are the two major raw materials used in the manufacture of microcapsule shells. In this case, the gelatin is dissolved in warm water and the water-insoluble substance to be encapsulated is dispersed therein. Gum arabic and water are added, the pH adjusted to approximately 4.0, and a complex coacervate of gelatin and gum arabic is formed surrounding the water-insoluble material. The gelatin is subsequently crosslinked, typically with an aldehyde such as formaldehyde or gluteraldehyde. Various other crosslinkers are known, including polyfunctional carbodiimides, anhydrides, and aziridines.

Interfacial polymerization involves the reaction of various monomers at the interface between two immiscible liquid phases to form a polymer film that encapsulates the dispersed phase. The monomers diffuse together and rapidly polymerize at the interface of the two phases. The degree of polymerization can be controlled by monomer reactivity, concentration, composition of either phase, and temperature. Microcapsules produced in this fashion may have shell walls comprised of polyamides, polyureas, polyurethanes, and polyesters, for example, as disclosed in U.S. Pat. No. 3,516,941, U.S. Pat. No. 3,860,565, U.S. Pat. No. 4,056,610, and U.S. Pat. No. 4,756,906. Post-crosslinking of the shell wall of these microcapsules with polyfunctional aziridines reduces porosity and improves structural integrity.

U.S. Pat. No. 3,516,941 teaches a process for the fabrication of microcapsules on the order of 5-25 microns. The process consists of the following steps. An aqueous insoluble fill material is dispersed into the precondensate prepared via dissolution of a water soluble, low MW urea-aldehyde precondensate comprising predominantly low MW reaction products of urea and formaldehyde (e.g., dimethylol urea) with a solids content of approximately 3-30 wt % of the aqueous precondensate. The resultant dispersion is maintained at a temperature of 10 C-50 C while the pH is adjusted to 1.0-3.5 by acid addition to initiate polymerization of the precondensate. The solution is rapidly agitated at 20 C-90 C for a time interval of at least one hour whereupon an aqueous slurry of water insoluble microcapsules with a urea-formaldehyde shell is formed.

U.S. Pat. No. 5,401,505 teaches the fabrication of microcapsules from polyfunctional aziridines. In this case, the shell wall is prepared via interfacial polymerization of a polyfunctional aziridine with at least one other polyfunctional coreactant selected from the class consisting of polyacid halides, polycarboxylic acids, polyamines, polyhydroxyl-containing compounds, polythiol-containing compounds, polyisocyanates, polyisothiocyanates, and mixtures thereof. The use of polyfunctional aziridines presents a number of advantages over the prior art. For example, polyfunctional aziridines readily react via interfacial polymerization with a wide variety of other organic polyfunctional groups in both aqueous and water-insoluble media. This breadth of reactivity with other functional groups enables the fabrication of microcapsules with shell walls covering a range of porosities, solubility characteristics, and mechanical and structural properties.

Application of Microcapsules to a Rigidized Foam:

Regarding rigidized foam of the preferred embodiments, any of the aforementioned techniques can be used to fabricate the encapsulated adhesive. However, the method described in U.S. Pat. No. 5,401,505 affords the greatest latitude in structural properties, such as compressive strength. In this case, microcapsules containing the epoxy monomer of a two-part epoxy adhesive and microcapsules containing the curing agent of a two-part epoxy adhesive are prepared. Both microcapsules will contain from 50-90 wt % of their respective fills with the balance being the shell. Since microcapsules prepared in this fashion can be stored as discrete materials, these microcapsules can be viewed as adhesive precursors.

Polyurethane (PU) or silicone foams can be prepared by techniques known to those skilled in the art. Regarding the manufacture of PU foam, the predominant method is the slabstock process which consists of precisely metering temperature-controlled reactants of the formulation to a mixing head and then depositing the liquid mixture onto a moving conveyor. The chemical reactions involved generate the foaming mass as well as the heat necessary to cure the resulting foam. The major ingredients involved are a polyol, a diisocyanate, usually toluene diisocyanate (TDI) and water. Other constituents include an emulsifier to stabilize the rising foam, several catalysts to control the reaction rate, and a number of optional ingredients such as colors, flame retardants, auxiliary blowing agents, fillers and other materials as needed to achieve specific foam properties. TDI reacts with the water to produce carbon dioxide gas (the primary foaming agent) and ureas. TDI also reacts with the polyol to produce the polyurethane.

Closed cell silicone foams may be prepared by the methods described in U.S. Pat. No. 4,608,396 and U.S. Pat. No. 4,593,049. Essentially, the method involves mixing together a polydiorganosiloxane, a hydroxylated polydiorganosiloxane, a platinum catalyst, an organohydrogensiloxane, a profoamer, or combinations thereof. Foams are prepared by mixing appropriate weight fractions of the siloxane components with the profoamer for 30-60 sec at room temperature.

In either case, simply incorporating the microencapsulated adhesive components into one of the reactant streams, either the TDI for the case of PU foams or the organosiloxane for the case of the silicone foams, will ensure that the resulting foam incorporates the microcapsules. As described above, microcapsules prepared using the method of U.S. Pat. No. 5,401,505 enables a wide range of control over the structural properties of the shell.

While encapsulating the adhesive components has not yet been perfected, trial and error would be required to determine the optimal shell composition necessary to ensure microcapsule rupture at pressures within the desired foam compression range.

Representative Example:

Note that the following is a conceptual example only that is provided without having actually prepared the microcapsules or foam. However, the science and technology to do so have been demonstrated.

Preparation of the Microcapsules (Epoxy Resin Fill):

Mondur MRS, 11.5 g, an MDI-based polyisocyanate available from Bayer, is dissolved in 100 ml of methylene chloride in which 5.0 g of (Chloromethyl)oxirane, 4,4′-(1-methylethylidene)bisphenol copolymer (a liquid epoxy resin with epoxy equivalent weight of 172-185, available from Aldrich Chemical as Araldite 506) is dissolved. This solution is added to a mixture of 8.0 g of 10% Vinol 205 polyvinyl alcohol (Air Products and Chemicals, Inc), 20% sulfuric acid (0.5 g), and 300 ml water and the mixture stirred at 750 rpm for two min. A 10 ml solution of 3.74 g of trimethylol propane tris[3-(2-methyl-aziridinyl)-propionate], a trifunctional aziridine available as CX-100 from DSM Neoresins, is added dropwise over one min and the mixture stirred for three hours to produce a slurry of capsules. The capsules were collected via filtration, washed with water, washed with methylene chloride, then dried in air and collected.

Preparation of the Microcapsules (Curing Agent Fill):

Mondur MRS, 11.5 g, an MDI-based polyisocyanate available from Bayer, is dissolved in 100 ml of methylene chloride in which 2.5-5.0 g of LP3, a mercaptan-terminated liquid polymer available from Toray Industries, and 0.25-0.5 g of 2,4,6-tris([dimethylamino]methyl)phenol is dissolved. This solution is added to a mixture of 8.0 g of 10% Vinol 205 polyvinyl alcohol (Air Products and Chemicals, Inc), 20% sulfuric acid (0.5 g), and 300 ml water and the mixture stirred at 750 rpm for two min. A 10 ml solution of 3.74 g of trimethylol propane tris[3-(2-methyl-aziridinyl)-propionate], a trifunctional aziridine available as CX-100 from DSM Neoresins, is added dropwise over one min and the mixture stirred for three hours to produce a slurry of capsules. The capsules were collected via filtration, washed with water, washed with methylene chloride, then dried in air and collected.

Preparation of the Microcapsule-Containing Silicone Foam:

A flexible, closed cell silicone foam bearing the aforementioned microcapsules may be prepared via the method outlined in U.S. Pat. No. 4,590,222. Compostion A is prepared by mixing 46.5 parts of a dimethylvinylsiloxy endblocked polydimethylsiloxane having a viscosity of 30 Pa-s at 25 C with 16 parts of a benzene-soluble resin copolymer of triorganosiloxy units and silicon dioxide units in a mole ratio of 0.7 siloxy:silicon dioxide where the triorganosiloxy units are trimethylsiloxy and dimethylvinylsiloxy such that the resin copolymer has approximately 1.8 wt % vinyl content, 36.0 parts of a 1:1 (w/w) mixture of microcapsules containing the epoxy resin and microcapsules containing the curing agent, and 0.13 parts of a Pt catalyst comprising a chloroplatinic acid complex of divinyltetramethyldisiloxane and polydimethylsiloxane (PDMS) fluid to provide 0.7 parts of platinum in the catalyst. Composition B is prepared by mixing together 4.0 parts of a hydroxyl endblocked PDMS having a viscosity of 0.04 Pa-s at 25 C and a hydroxyl content of approximately 3.25 wt % and 1.0 part of a trimethylsiloxy endblocked polymethylhydrogensiloxane having a silicon-bonded hydrogen atom content of approximately 1.6 wt %. A foam is prepared by mixing 100 g of Composition A with 18.0 g of Composition B for 30-60 sec at room temperature.

While the present invention has been described with reference to the details of the embodiments of the invention shown in the drawing, these details are not intended to limit the scope of the invention as claimed in the appended claims.

What is claimed is:

1. A rigidized compliant foam comprising:
a closed cell foam;
a plurality of resin microcapsules and a plurality of curing agent microcapsules being dispersed in said closed cell foam;
said closed cell foam being compressed by a predefined normal force to produce the rigidized compliant foam.

2. A rigidized compliant foam as recited in claim 1 wherein each of said plurality of resin microcapsules and each said plurality of curing agent microcapsules include a shell having a set rupture force; said set rupture force being less than said predefined normal force.

3. A rigidized compliant foam as recited in claim 1 wherein said plurality of resin microcapsules and said plurality of curing agent microcapsules comprise an encapsulated adhesive.

4. A rigidized compliant foam as recited in claim 1 wherein said plurality of resin microcapsules comprises a multifunctional epoxy resin.

5. A rigidized compliant foam as recited in claim 1 wherein said plurality of curing agent microcapsules is a curing agent selected from the group consisting of amine, polyamine, Lewis acid, mercaptans, and mercaptan-terminated polymers.

6. A rigidized compliant foam as recited in claim 1 wherein said plurality of resin microcapsules and said plurality of curing agent microcapsules comprise a room-temperature curable adhesive.

7. A rigidized compliant foam as recited in claim 1 wherein each of said plurality of resin microcapsules and each said plurality of curing agent microcapsules include a urea formaldehyde shell.

8. A rigidized compliant foam as recited in claim 1 includes a laminated layer comprising a pressure sensitive adhesive; said closed cell foam secured to a substrate with said pressure sensitive adhesive.

9. A rigidized compliant foam as recited in claim 1 wherein said plurality of resin microcapsules and said plurality of curing agent microcapsules include a predefined ratio of said plurality of resin microcapsules to said plurality of curing agent microcapsules.

10. A method for implementing a rigidized compliant foam comprising the steps of:
encapsulating a resin to provide a plurality of resin microcapsules;
encapsulating a curing agent to provide a plurality of curing agent microcapsules;
producing a closed cell foam having said plurality of resin microcapsules and said plurality of curing agent microcapsules dispersed in said closed cell foam; and
compressing said closed cell foam by a predefined normal force to produce the rigidized compliant foam.

11. A method for implementing a rigidized compliant foam as recited in claim 10 wherein encapsulating said resin includes in situ polymerization of urea formaldehyde shells around said resin.

12. A method for implementing a rigidized compliant foam as recited in claim 10 wherein encapsulating said curing agent includes in situ polymerization of urea formaldehyde shells around said curing agent.

13. A method for implementing a rigidized compliant foam as recited in claim 10 includes providing a predefined ratio of said plurality of resin microcapsules to said plurality of curing agent microcapsules.

14. A method for implementing a rigidized compliant foam as recited in claim 10 wherein encapsulating said resin includes encapsulating a multifunctional epoxy resin.

15. A method for implementing a rigidized compliant foam as recited in claim 10 wherein encapsulating said curing agent includes encapsulating a curing agent selected from the group consisting of amine, polyamine, Lewis acid, mercaptans, and mercaptan-terminated polymers.

16. A method for implementing a rigidized compliant foam as recited in claim 10 wherein encapsulating said resin includes providing said plurality of resin microcapsules having a shell with a set rupture force; said set rupture force being less than said predefined normal force.

17. A method for implementing a rigidized compliant foam as recited in claim 10 wherein encapsulating said curing agent includes providing said plurality of curing agent microcapsules having a shell with a set rupture force; said set rupture force being less than said predefined normal force.

18. A method for implementing a rigidized compliant foam as recited in claim 10 includes providing a foam resin, said foam resin comprising a selected one of polyurethane and silicone.

19. A method for implementing a rigidized compliant foam as recited in claim 18 includes dispersing said plurality of resin microcapsules and said plurality of curing agent microcapsules in said form resin under low shear mixing conditions.
